(19) United States
(12) Patent Application Publication
(10) Pub. No.: US 2020/0325745 A1
(43) Pub. Date: Oct. 15, 2020

(54) SEABED CORE SAMPLING DEVICE AND CORE SAMPLING METHOD

(71) Applicant: KOKEN BORING MACHINE CO., LTD., Tokyo (JP)

(72) Inventors: Sachihiro SUENAGA, Tokyo (JP); Shinichi TAKAGAWA, Tokyo (JP); Tetsuya FUKAZAWA, Tokyo (JP); Shirou YOSHIOKA, Tokyo (JP); Naoki UTO, Tokyo (JP); Yuji IMAI, Tokyo (JP); Satoshi SORIMACHI, Tokyo (JP); Kenshiro ITODA, Tokyo (JP); Fumisato TAJIMA, Tokyo (JP)

(73) Assignee: Koken Boring Machine Co., Ltd., Tokyo (JP)

(21) Appl. No.: 16/335,207

(22) PCT Filed: Sep. 19, 2017
(86) PCT No.: PCT/JP2017/033790

§ 371 Date: Jun. 11, 2020

(30) Foreign Application Priority Data
Sep. 23, 2016 (JP) 2016-185361

(51) Int. Cl. E21B 25/18; G01N 1/08; B63G 8/00

(52) U.S. Cl. CPC E21B 25/18; B63G 2008/005; B63G 8/001; G01N 1/08

(57) ABSTRACT

Core sampling is enabled over a wide range of areas of the seabed. The present device is provided with a main robot that is moved underwater by remote operation, and a sampling robot that is connected to a manipulator that is attached to the main robot, and that can move in relation to the seabed. The sampling robot is provided with a core tube for excavating the seabed by being rotated and propelled, introducing into the core tube a core of the seabed by the excavation, and breaking the introduced core into core pieces. The main robot is provided with a core rack for storing the core pieces taken from inside the core tube.

### TECHNICAL FIELD

The present invention relates to a seabed-core-sampling device and core-sampling method for obtaining seabed cores as samples for geological research concerning the seabed.

### BACKGROUND ART

Many conventional seabed-core-sampling devices for obtaining core from the seabed have been developed (See Patent Documents 1 to 4). These conventional core-sampling devices bore into the seabed and obtain core samples while a device is on the seabed. Each conventional core-sampling device has a frame body to be placed on the seabed, and it includes a spindle to which a core tube is attached, a motor to rotate the spindle, a motor to feed or retract the spindle, and a battery to power the motors. All the components are disposed to the frame body.

Each of the prior-art core-sampling devices performs sampling of cores while a device is on the seabed, and a spindle feeds a core tube by rotating by being driven by the motor. The core tube bores into the seabed and, by the action of the spindle, obtains core samples that are then fed into the core tube.

### LIST OF CITED DOCUMENTS

### Patent Documents

[Patent Document 1] Japanese Unexamined Patent Application Publication No. H07-293182.
[Patent Document 2] Japanese Unexamined Patent Application Publication No. H07-213361.
[Patent Document 3] Japanese Unexamined Patent Application Publication No. 2006-83552.
[Patent Document 4] Japanese Unexamined Patent Application Publication No. 2011-226084.

### SUMMARY OF THE INVENTION

### Technical Problems to be Overcome

A seabed's surface layer typically includes a cobalt-rich crust layer and/or a methane-hydrate layer, and investigative research of the layers requires that a wide range of cores be obtained from the seabed's surface layer. However, prior-art core-sampling devices are large and heavy, and they are not suitable for being frequently moved on the seabed. Thus, prior-art core-sampling devices are not suitable for sampling the seabed's surface layer over a wide range of areas of the seabed at a depth of 100 m to 300 m. Also, the azimuth direction of the obtained core samples cannot be known by prior-art core-sampling devices. Therefore, the distribution of the components of the researched seabed, such as cobalt-rich crust layers and/or methane-hydrate layers cannot be known by prior-art core-sampling devices.

This invention is made considering the above-mentioned problems, and it is intended to provide a core-sampling device that enables core sampling over a wide range of areas of the seabed and a wide range of core-sampling methods. Further, this invention, by making it possible to know the azimuth direction of obtained cores, is intended and able to discover the distribution of the components in the researched seabed.

### Solution to the Problems

The seabed core-sampling device according to this invention comprises a main robot that is moved under the sea by remote control; a sampling robot that is connected to the main robot through a manipulator attached to the main robot, that is movable with respect to the seabed, and that has a core tube that excavates the seabed by being rotated and that feeds the seabed and introduces core samples from the seabed and then breaks the introduced core samples into core pieces. The main robot has a core rack to house the core pieces from the core tube.

In this invention's seabed-core-sampling device, the core tube comprises an outer tube and an inner tube that forms a core passage and that is unable to rotate in the outer tube. The core tube is configured to introduce core samples into the core passage by feeding the core tube by rotating the outer tube, and to break the core that is in the core passage into core pieces. The sampling robot comprises a drill head to rotate the core tube; a feeding mechanism to feed the core tube; and a gyro-sensor to detect the direction of the drill head during excavation. The core tube has a (1) core marker inside the core passage to mark the core that is introduced into the core passage, and (2) a core kicker that is inclined and protrudes inside of the core passage to break into core pieces the core that is introduced into the core passage. In this invention's seabed-core-sampling device, the core rack has multiple core cases to house the core pieces, and it is capable of switching core cases so that one core case moves to the position to house each core piece. Further, the core rack has a rotatable rack body to which the multiple core cases are disposed circumferentially at equal intervals, wherein the switching of core cases is done by the rotation of the rack body. Also, the sampling robot further comprises and to a wobble-prevention mechanism that digs into the seabed to maintain the excavating position of the sampling robot.

This invention's core-sampling method includes connecting a sampling robot via a manipulator to a main robot that is moved under the sea by remote control; moving the sampling robot with respect to the seabed; introducing core of the seabed in a core tube by excavating the seabed by rotating and feeding the core tube; breaking the core into core pieces; and housing the core pieces in the core rack provided in the main robot.

### Advantageous Effects of the Invention

According to this invention, because a sampling robot is connected to a main robot that moves under the sea and obtains, in a core tube, core of the seabed, core sampling over a wide range of areas of the seabed is possible. Also, because the inner tube is unable to rotate, and the core in the inner tube is marked and broken into core pieces and the direction of the drill head during excavation is detected, it becomes possible to know with a high level of certainty the azimuth direction of obtained core pieces, and so the distribution of the components in the researched seabed.

### BRIEF DESCRIPTIONS OF THE DRAWINGS

FIG. 1 This figure is a conceptual view that shows entire core-sampling device of one embodiment of the present invention.

FIG. 2 This figure is a perspective view that shows the state of sampling by the core-sampling device.

FIG. 3 This figure is a side view that shows the movement of a sampling robot.

FIG. 4 This figure is a side view that shows the position of a core-sampling device when it is ready to excavate the seabed.

FIG. 5 This figure is a side view that shows the core-sampling device while excavating the seabed.

FIG. 6 This figure is a sectional view from one side that shows a core tube, a drill head, and a gyro-sensor when assembled together.

FIG. 7 This figure is a sectional view from side other than the side shown in FIG. 6.

FIG. 8 This figure is a sectional view that shows a core tube.

FIG. 9 This figure is a partial sectional view that shows the inside of a core tube.

FIG. 10 This figure is an exploded perspective view that shows a core rack.

FIG. 11 This figure is a perspective view that shows the movement of a core rack.

FIGS. 12 (A) and (B) in this figure are a bottom view and aside view, respectively, each showing a wobble-prevention mechanism.

FIG. 13 This figure is a conceptual view that shows another entire embodiment.

FIG. 14 This figure is a perspective view that shows the state of sampling by the core-sampling device of said other embodiment.

FIG. 15 This figure is a side view that shows the position of said core-sampling device when it is to excavate the seabed.

FIG. 16 This figure is a side view that shows the state of said core-sampling device while excavating the seabed.

FIG. 17 This figure is a side view that shows another position of said core-sampling device when it is ready to excavate the seabed.

### DESCRIPTIONS OF THE EMBODIMENTS

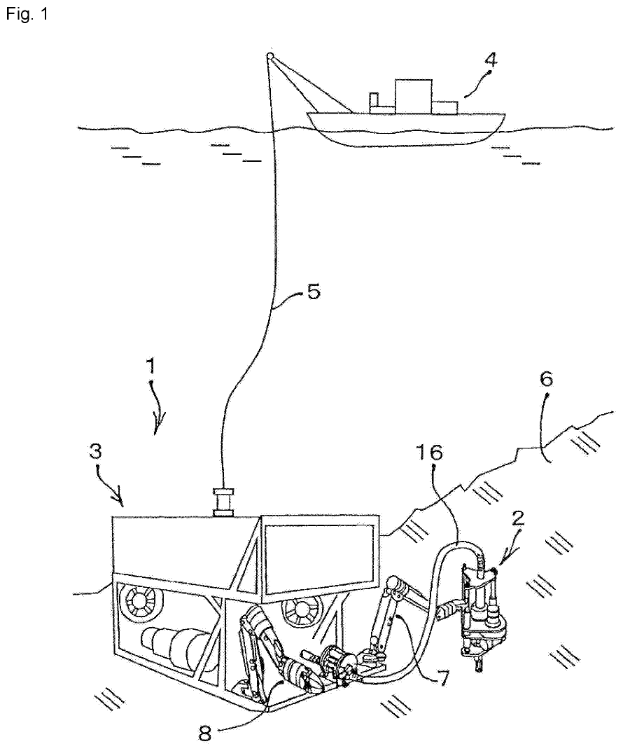

FIG. 1 shows the entire core-sampling device 1 of an embodiment of the present invention. The core-sampling device 1 of this embodiment has a main robot 3 in addition to a sampling robot 2 that executes primary core sampling in the seabed. The main robot 3 is connected to an operating ship 4 through a cable 5, and is moved under the sea by remote control from the operating ship 4 via the cable 5. The main robot 3 provides electric power and hydraulic power to the sampling robot 2 to drive the sampling robot 2. Said electric power and hydraulic powers are provided by order from the operating ship 4.

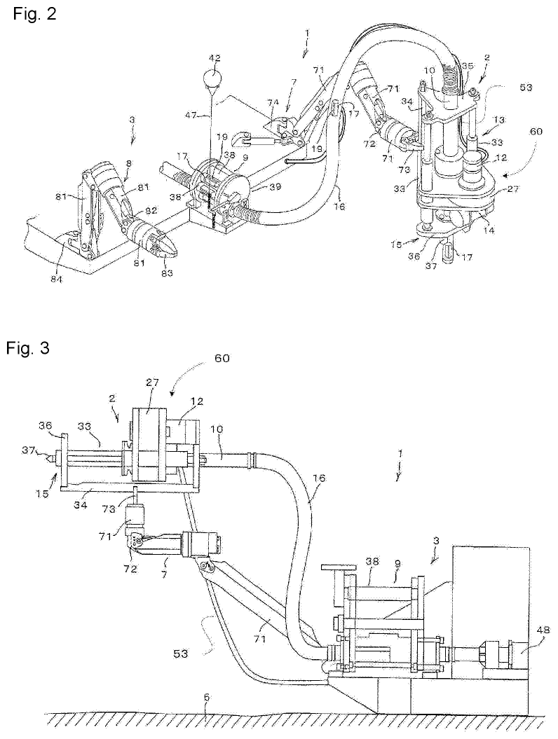

FIG. 2 shows the state of sampling by the core-sampling device. As shown in FIG. 1 and FIG. 2, the main robot 3 has a first manipulator 7 and a second manipulator 8. Either of the manipulators 7 or 8 (manipulator 7, in the example illustrated by FIG. 1 and FIG. 2) grabs the sampling robot 2 and moves the sampling robot 2 with respect to the seabed. The sampling robot 2 moves to a sampling place in the seabed 6, and there executes core sampling. The other manipulator 7 or 8 (manipulator 8, in the example illustrated by FIG. 1 and FIG. 2) executes a switching operation of a core rack 9, as described later. In this embodiment, the core rack 9 is attached to the main robot 3. The two manipulators 7, 8 are controlled by orders from the operating ship 4.

In each of the manipulators 7, 8, multiple arms 71, 81 are connected by articulators 72, 82, and the arms 71, 81 at the sides of the base are attached to the main robot through brackets 74, 84, and clamp jaws 73, 83 are fixed to the arms 71, 81 at the sides of the tips of the arms 71, 81. The manipulators 7, 8 can be bent, rotated, expanded, and contracted by multiple arms 71, 81 connected through articulators 72, 82. Each of the clamp jaws 73, 83 is operated by hydraulic pressure to open and close. The clamp jaws 73 of the first manipulator 7 operate on the sampling robot 2, and the clamp jaws 83 of the second manipulator 8 operate on the core rack 9.

FIG. 3 to FIG. 7 show the sampling robot 2. As shown in these Figs. and in FIG. 2, the sampling robot 2 has a hollow connecting tube 10 to which a core tube 11 is detachably connected, and, a drill head 60, a feed mechanism 13, a gyro-sensor 14 and a wobble-prevention mechanism are arranged circumferentially around the core tube 11.

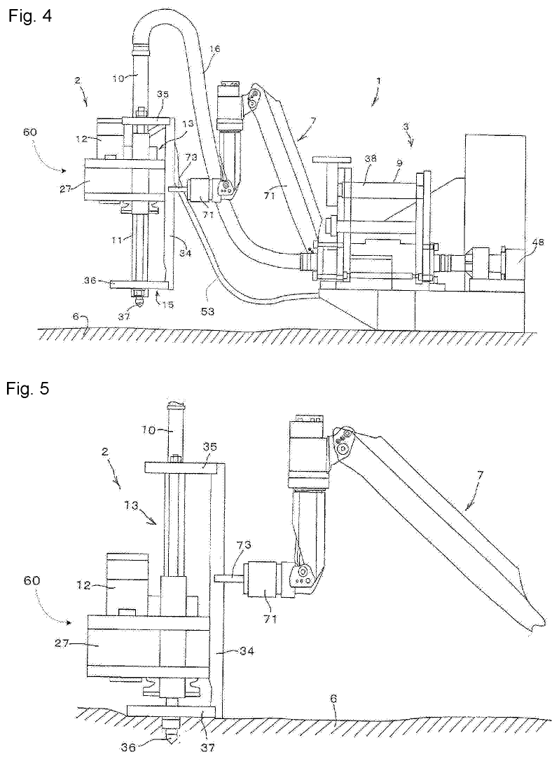

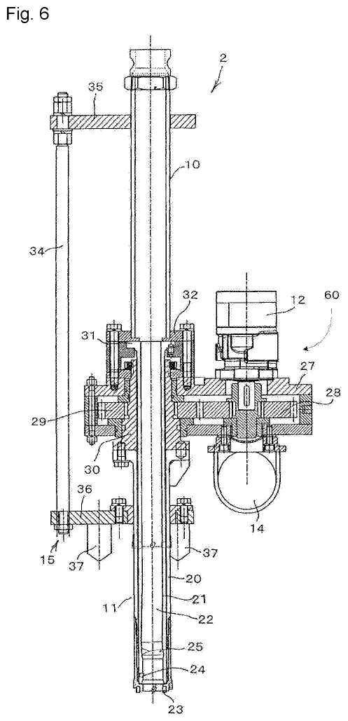

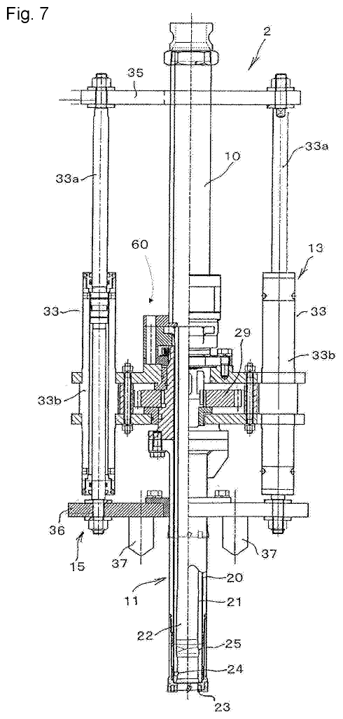

As shown in FIG. 6 and FIG. 7, the inside of the hollow connecting tube 10 and the inside of the inner tube 21 (core passage 22) of the core tube 11 communicate by coaxial connection of the hollow connecting tube 10 and the core tube 11. A suction hose 16 is connected to the end of the core tube 10 opposite to the core tube 11 in the hollow connecting tube 10 (See FIG. 2). The other end of the suction hose 16 is connected to a suction pump 48 in the main robot 3 (See FIG. 3 and FIG. 4). By this configuration, a core piece 17 that is introduced into the core passage 22 is moved through the connecting tube 10 to the suction hose 16, and then the core piece 17 can be transferred to a core rack 9, as will be described below.

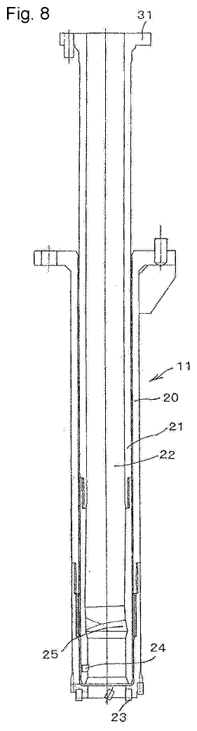

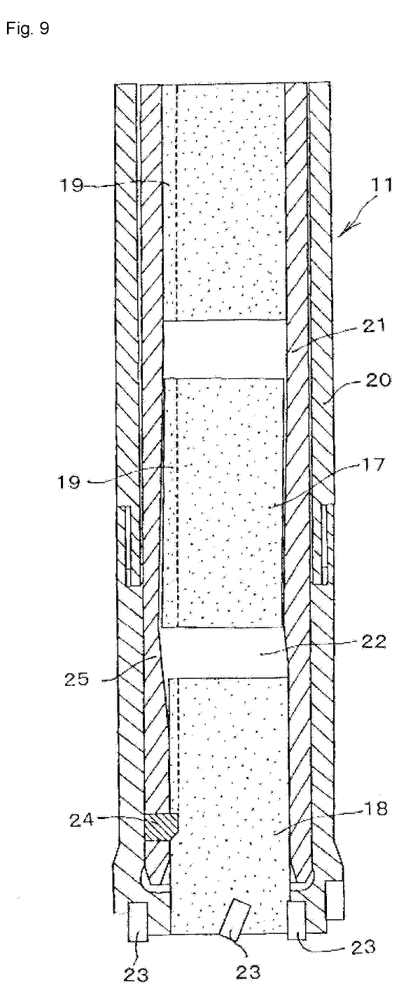

FIG. 8 and FIG. 9 show the core tube 11, which has a double-tube configuration that comprises an outer tube 20 and an inner tube 21 that is inserted into the outer tube 20. Multiple tips 23 are disposed to the tip of the lower end of the outer tube 20.

The inner tube 21 is inserted into the outer tube 20; it is unable to rotate with respect to the outer tube 20. The inner tube 21 is hollow in its axial direction at the core passage, and the core 18 of the seabed 6 is introduced into the core passage 22 by excavating the seabed 6. A core marker 24 is formed at the tip of the lower end of the inner tube 21, and a core kicker 25 is formed at the upper side of the core marker 24.

The core marker 24 includes a blade that extends to the inside of the core passage 22 of the inner tube 21, and the core marker 24 scrapes against the outer surface of the core 18 that is introduced into the core passage 22, thereby forming a mark 19 on said outer surface. Because the inner tube 21 is unable to rotate, the mark 19 that is formed on the core 18 (core piece 17) by the core marker 24 is a straight line. The azimuth direction of a core pieces 17 can be known by the core mark 19 formed on the core piece 17 by the core marker 24 and by the direction of the drill head 60 as detected by a gyro-sensor 14, as will be described below.

The core kicker 25 is formed by slopingly protruding a part of the core passage 22 above the core marker 24. The core kicker 25 is used to decenter the core 18 after the core 18 has passed through the core marker 24, and this decentering breaks the core 18 into core pieces. Hence, a linear mark 19 is on the outer surface of each core piece 17. The core piece broken by the core kicker 25 is from 100 mm to 200 mm in length.

The drill head 60 has a hydraulic motor 12, a gear box 27, a drive gear 28 and a driven gear 29. The hydraulic motor 12 is the drive that rotates the outer tube 20 of the core tube 11. The hydraulic motor 12 is attached to the gear box 27, and it applies rotational power to the outer tube 20 when attached to the gear box 27. In order to do that, there are provided the drive gear 28, which is attached to the drive shaft of the hydraulic motor 12, and the driven gear 29, which is engaged with the drive gear 28. A coupling tube 30 is attached to the upper side of the outer tube 20 by a screw clamp, and the driven gear 29 is attached to the coupling tube 30. By this configuration, when the hydraulic motor 12 rotates, the outer tube 20 rotates by the rotational power transmitted to the outer tube 20 through the drive gear 28, the driven gear 29, and the coupling tube 30. In FIG. 2 to FIG. 4, Reference No. 53 denotes a hydraulic hose that supplies hydraulic oil from the main robot 3 to the hydraulic motor 12 in the drill head 60. In contrast, the inner tube 21 is unable to rotate, because the inner tube 21 is fixed at the flange 31 at the upper end of the inner tube 21 to a fixed block 32 by a screw clamp, and the fixed block 32 is fixed to the gear box 27 by a screw clamp. Therefore, the core tube 11 is fed in the state that only the outer tube 20 rotates and the inner tube 21 does not rotate when the seabed 6 is excavated.

The gyro-sensor 14 is fixed to the outside of the gear box 27 at a position below the hydraulic motor 12 in the drill head 60, and it detects the direction of the drill head 60 during excavation of the seabed. As illustrated in the figures, the gyro-sensor 14 is arranged in a pressure container.

As shown in FIG. 2, FIG. 6, and FIG. 7, a feed mechanism 13 is formed by a pair of feed cylinders 33 arranged on opposite sides of the connecting tube 10. The configuration of the feed mechanism 13 and the peripherals will now be explained. A clamp rod 34 is provided parallel to the pair of feed cylinders 33. As shown in FIG. 2, the clamp rod 34 is clamped by clamp jaws 73 of the first manipulator 7. By being clamped by the clamp jaws 73 of the first manipulator 7, the entire sampling robot 2 is movable with respect to the seabed. An upper plate 35 is connected to the upper portion of the clamp rod 34 and to the upper portions of piston rods 33a of the pair of feed cylinders 33. The connecting tube 10 is movable up and down through the upper plate 35. An anchor plate 36 of a wobble-prevention mechanism 15 is connected to the lower portion of the clamp rod 34 and to the lower portions of the piston rods 33a of the pair of feed cylinders 33. The core tube 11 is movable up and down through the anchor plate 36. In this configuration, the connecting tube 10 and the core tube 11 feed if the pair of feed cylinders 33 are extended. The drill head 60 and the gyro-sensor 14 also feed integrally with the connecting tube 10 and the core tube 11.

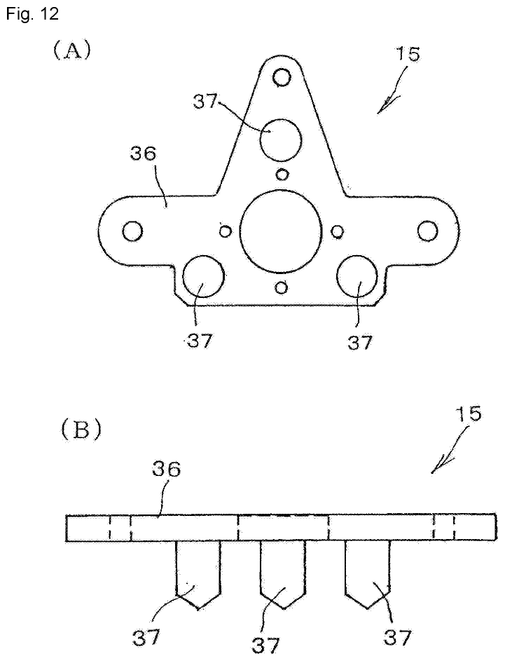

FIG. 12 shows the wobble-prevention mechanism 15, which is formed by the anchor plate 36 and anchor legs 37. The anchor plate 36 is arranged to bridge the lower end of the clamp rod 34 and the lower ends of the piston rods 33a of the pair of feed cylinders 33. The anchor legs 37 are formed in the anchor plate 36 around the core tube 11 at places so as to trisect the circumference of the core tube 11 (See FIG. 12). The anchor legs 37 dig into the seabed 6 by the pressing power of the first manipulator 7 when the sampling robot 2 is on the seabed 6. In this way, the position of a core-sampling robot 2 is maintained when it is to excavate the seabed.

In this embodiment, a core rack 9 is provided so as to house core pieces 17. As shown in FIG. 2, the core rack 9 is attached to the main robot 3. The core rack 9 holds the core cases 38 and enables the core cases 38 to be switched. Each core case 38, which is formed of a transparent resin, houses one core piece 17.

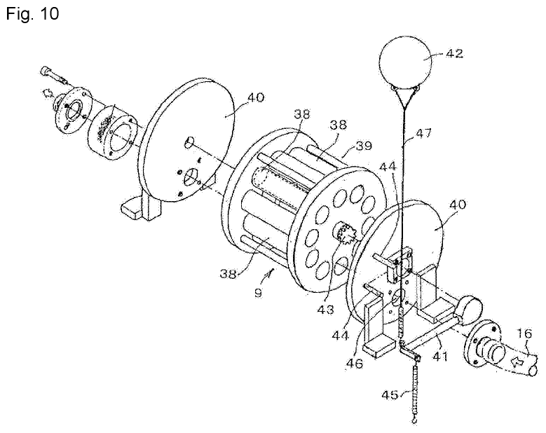

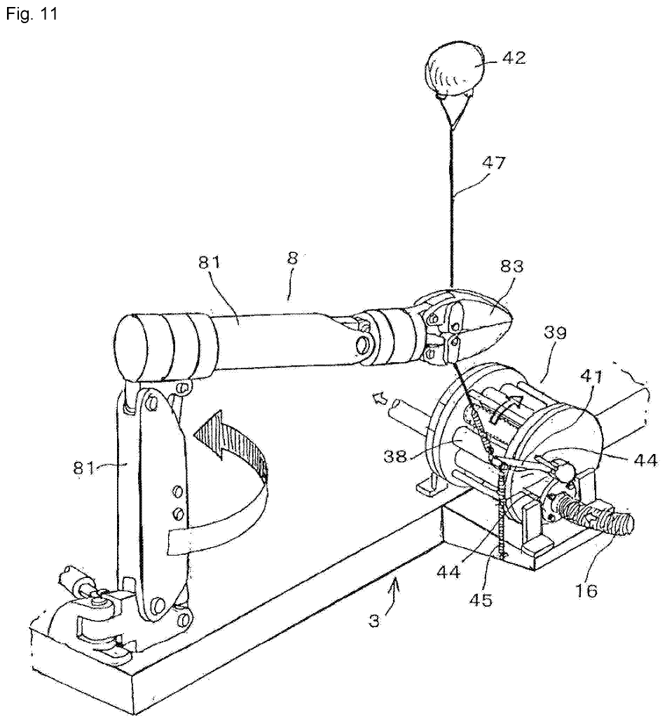

FIG. 10 and FIG. 11 show the core rack 9, which has (1) a rack body 39 in which multiple (ten, for example) tubular core cases 38 are disposed circumferentially at equal intervals, (2) a pair of rack plates 40 to interpose the rack body 39 between the plates, (3) a lever 41 to rotate the rack body 39, and (4) an operating ball 42 to turn the lever 41 in a specified direction. The operating ball 42 is made of material that floats on water, and the operating ball 42 is drifting under the sea. The core rack 9 is connected to the suction hose 16 from the sampling robot 2, and a continuous hole 46 to enable the suction hose 16 and a core case 38 to be communicated is formed in the rack plate 40 on the suction hose 16 side. In this way, the core cases 38 in the rack body 39 communicate with the core passage 22 of the inner tube 21 through the suction hose 16. By this configuration, each of the core pieces 17 that are in the inner tube 21 is inserted into each of the core cases 38.

Ratchet teeth 43 are formed along the axis of rotation of the rack body 39, and a ratchet lever (not shown in the figures.) that engages the ratchet teeth 43 is formed on the opposite side of the lever 41. By this configuration, the rack body 39 rotates in one direction only. In FIG. 10, Ref. No. 44 denotes a pair of stopper pins that restrict the rotational angle of the ratchet lever within a predetermined limit (36 degrees, for example), and Ref. No. 45 denotes a return spring that causes the lever 41 to return to its original position. The space between the pair of stopper pins is set to switch the core cases 38 so that the next core case 38 is aligned with the continuous hole 46 (suction hose 16).

FIG. 11 shows the operation by which switching of core cases 38 is effected. An operation wire 47 is clamped by the clamp jaws 83 of the second manipulator 8, and the second manipulator 8 turns upward. By this operation, the lever 41, which is connected to the operation wire 47, turns in the same direction as the second manipulator 8 (upward) within the range restricted by the stopper pins 44. By this turning, the next core case 38 is moved to the position to communicate with the suction hose 16, and the next core case 38 is in a standby state, ready to receive a core piece to be introduced. If the clamping of operation wire 47 by the clamp jaws 83 of the second manipulator 8 is released, the lever 41 returns to its initial position by the spring force of a return spring 45.

Next, the operation by which core pieces 17 are obtained from the seabed 6 will now be explained. As shown in FIG. 1, the first manipulator 7 holds the sampling robot 2 by clamping the clamp rod 34, and in this state the main robot 3 is moved near to the sampling point of the seabed 6. FIG. 3 shows the state in which the first manipulator 7 holds the sampling robot 2, in which state the sampling robot 2 is moved to the sampling point by rotating, extending and retracting the first manipulator 7. FIG. 4 shows the state in which the sampling robot 2 is at the sampling point, and the first manipulator 7 holds the sampling robot 2 upright with respect to the seabed 6.

In this state the first manipulator 7 places the sampling robot 2 on the seabed 6. Then, as shown in FIG. 5, the first manipulator 7 pushes the sampling robot 2 on the seabed 6 through the clamp rod 34, which is clamped by the first manipulator 7, and causes the anchor legs 37 to dig into the seabed 6, so as to stabilize the excavating position of the sampling robot 2. At this time, the first manipulator 7 maintains the clamping of the clamp rod 34, which also stabilizes the excavating position of the sampling robot 2.

After that, the outer tube 20 is rotated by the hydraulic motor 12 that is in the drill head 60, and the pair of feed cylinders 33 of the feed mechanism 13 are simultaneously extended. By this operation the outer tube 20 rotates, and the core tube 11 feeds and excavates the seabed 6, and core 18 is introduced into the core passage 22 of the inner tube 21, which does not rotate. At this time, the suction pump 48 in the main robot 3 is activated, and suction power is applied to the suction hose 16 and to the core passage 22. The direction of the drill head 60 during excavation is detected by the gyro-sensor 14, and the information detected is transmitted to the operating ship 4.

As shown in FIG. 9, the core that has been introduced in the core passage 22 of the inner tube 21 passes through the core marker 24 that is provided in the core passage 22, the outer surface of the core 18 is scraped during that passing process, and thereby a linear mark 19 is put on the core 18 along the axis direction of the core 18. The core 18 is moved further in the core passage 22 by further feeding of the core tube 11 into the seabed, the received core 18 reaches the core kicker 25, which breaks the received core 18 into core pieces 17. The mark 19 is put on the core pieces 17 by the core marker 24. The core pieces 17 are transferred from the core passage 22 to the suction hose 16 by water streaming in the suction hose 16 and in the core passage 22 by the suction power of the suction pump 48. Then each of the core pieces 17 is transferred to one of the core cases 38 and is housed therein (See FIG. 2).

In this core-sampling operation, it is possible to detect the azimuth direction of the obtained core pieces 17 because the mark 19 is put on each core piece 17 that is obtained by excavating the seabed 6, and simultaneously the direction of the drill head 60 is detected by the gyro-sensor 14. Subsequent to the operations above, core pieces 17 can be obtained in another place by moving the sampling robot 2 to that other place. Also, it is possible to continue sampling operations in an excavation hole by using an elongated core tube 11 and/or an elongated connecting tube 10 by jointing such tubes.

By this embodiment, because the sampling robot 2 moves with respect to the seabed 6 and puts the core pieces 17 into the inner tube 21 of the core tube 11 by driving the drill head 60 at the excavating point after said movement of the sampling robot 2, it is possible to do core sampling over a wide range of locations of the seabed 6. Because (1) the inner tube 21 is unable to rotate, (2) the mark 19 is put on the core 18 that has been received in the inner tube 21 and then broken into core pieces 17, and (3) the direction of the drill head during excavating is detected, it becomes possible to know with certainty the azimuth direction of obtained core pieces, and so the distribution of the components in the researched seabed.

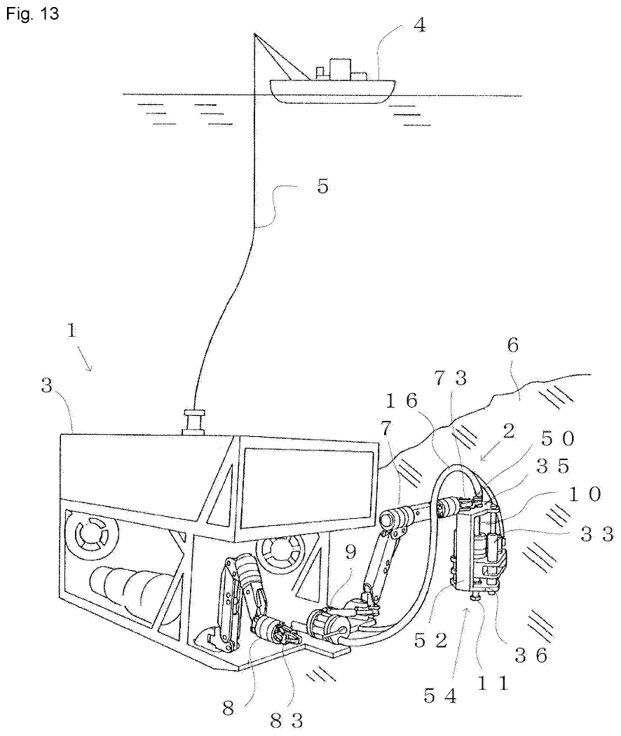

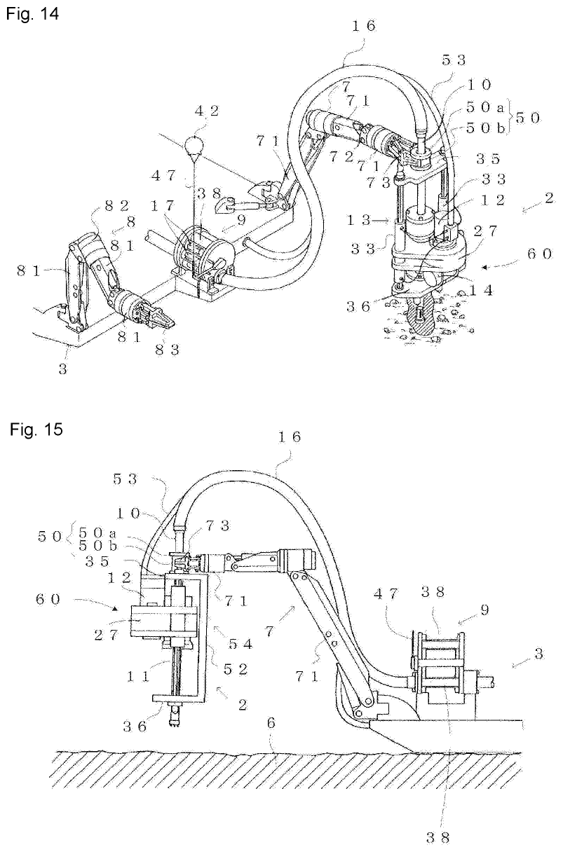

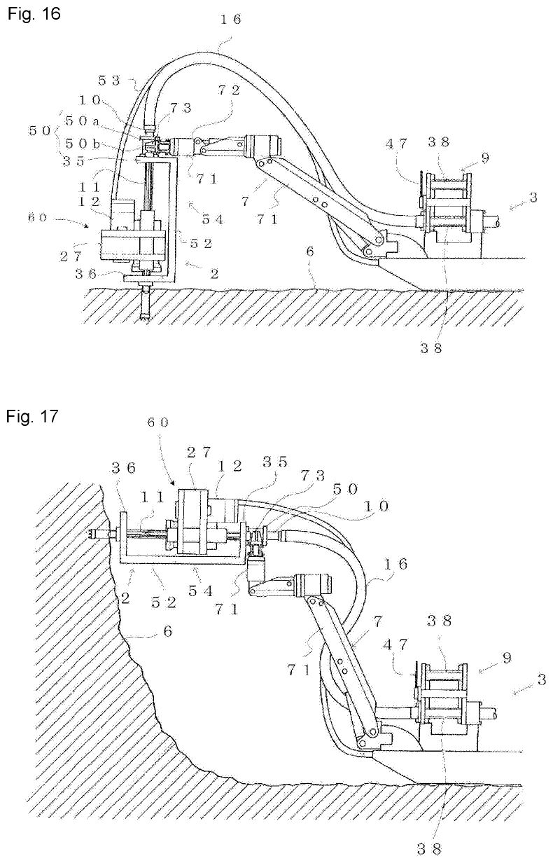

FIG. 13 to FIG. 17 show the core-sampling device 1 of a second embodiment of this invention. The members that are same as those of the former embodiment have the same reference numbers as those of the former embodiment. FIG. 13 corresponds to FIG. 1 of the former embodiment, FIG. 14 corresponds to FIG. 2, FIG. 15 corresponds to FIG. 4, and FIG. 16 corresponds to FIG. 5. FIG. 17 shows the state of laterally excavating and sampling cores in the case of a rise of the floor of the seabed 6. In this embodiment, the part on which the first manipulator 7 clamps the sampling robot 2 differs from the part in the former embodiment, but the rest of the configuration is same as that of the former embodiment.

In the sampling robot 2, an upper plate 35 and an anchor plate 36 are formed integrally with a tabular connecting plate 52, and the upper plate 35, the anchor plate 36, and the connecting plate 52 form a square U-shaped supporting frame 54. The square U-shaped supporting frame 54 forms the skeleton of the sampling robot 2.

A tube body for clamp 50 is provided to protrude from the upper plate 35. A hollow connecting tube 10 is movable up and down through the tube body for clamp 50, and a core tube 11 is detachably connected to the connecting tube 10. An inner tube 21 that is unable to rotate and that forms a core passage 22 is inserted into an outer tube 20 that is driven by a drill head 60 so as to rotate, and the entire core tube 11 feeds and excavates the seabed 6. By this excavation, core 18 is introduced into the core passage 22 and is broken into core pieces 17 within the core passage 22. A core marker 24 puts a mark 19 on each of the core pieces 17. The direction of the drill head is detected by a gyro-sensor 14. This configuration is the same as that of the former embodiment. Ref. No. 53 denotes a hydraulic hose that supplies hydraulic oil from a main robot 3 to a hydraulic motor 12 in the drill head 60.

In this embodiment, a first manipulator 7 clamps the tube body for clamp 50. As shown in FIG. 14 to FIG. 16, the tube body for clamp 50 is formed by upper and lower flanges 50a and a cylindrical clamp portion 50b. Clamp jaws 73 of the first manipulator 7 clamp the clamp portion 50b. In this state of clamping, the upper and lower flanges 50a can prevent aberration of the position of the clamp jaws 73. The outside diameter of the clamp portion 50b is large and can be clamped by a strong force. Because the tube body for clamp 50 is provided in the supporting frame 54 that forms the skeleton of the sampling robot 2, it is possible to surely move the sampling robot 2 under the sea by operation of the first manipulator 7, to place the sampling robot 2 on the seabed 6, and to maintain the position of the sampling robot 2 while excavating the seabed 6; for example, in excavating the seabed 6 with the sampling robot 2 in an upright state with respect to the seabed 6 (See FIG. 16), or in laterally excavating a rise in the seabed 6 (See FIG. 17), or in excavating the seabed 6 with the sampling robot 2 in an inclined state.

In the embodiment shown in FIG. 13 to FIG. 17, the sampling robot 2 moves with respect to the seabed 6 and obtains core pieces 17 and then puts the core pieces 17 in the inner tube 21 of the core tube 11 by driving the drill head 60 at the excavating point after said movement, making it possible to do core sampling over a wide range of areas of the seabed 6. Because the inner tube 21 is unable to rotate and a mark 19 is put on the core 18 that has been obtained and put in the inner tube 21 and broken into core pieces 17, and because the direction of the drill head during excavation is detected, it becomes possible to surely know the azimuth direction of obtained core pieces.

### LIST OF REFERENCE NUMBERS

1: core-sampling device
2: sampling robot
3: main robot
6: seabed
7: first manipulator
8: second manipulator
9: core rack
10: connecting tube
11: core tube
12: hydraulic motor
13: feed mechanism
14: gyro-sensor
15: wobble-prevention mechanism
16: suction hose
17: core piece
18: core
19: mark
20: outer tube
21: inner tube
22: core passage
24: core marker
25: core kicker
33: feed cylinder
37: anchor leg
60: drill head

1.-7. (canceled)

8. A seabed-core-sampling device that comprises: a main robot that is moved under the sea by remote control; a sampling robot that is connected to the main robot via a first manipulator attached to the main robot, and that is movable with respect to the seabed; wherein the sampling robot has a core tube that excavates the seabed by rotation and feeds the seabed, and that introduces the core from the seabed and breaks the introduced core into core pieces; wherein the main robot has a core rack to house the core pieces in the core tube;
wherein the core rack has a rotatable rack body to which the multiple core cases are disposed circumferentially and the rack body is disposed rotatably to the main robot; and a lever connected to an operation wire and the lever is to rotate the rack body;
wherein the main robot further has a second manipulator to clamp the operation wire and to switch the core cases by rotating the rack body by turning of the lever; and
the core tube at the sampling robot side and the core rack at the main robot side are connected through a suction hose, and the core pieces are transferred from the core tube to the core rack by the suction force of a suction pump provided in the main robot.

9. The seabed-core-sampling device described in claim 8, wherein the core tube comprises an outer tube; and an inner tube that forms core passage and is unable to rotate in the outer tube; wherein the core tube having a configuration to introduce the core in the core passage by feeding the whole core tube by rotation of the outer tube and to break the core in the core passage into core pieces; wherein the sampling robot comprising: a drill head to rotate the core tube; a feed mechanism to feed the core tube; and a gyro-sensor to detect the direction of the drill head during excavating.

10. The seabed-core-sampling device described in claim 9, wherein the core tube comprises a core marker provided inside of the core passage to mark the core that has been introduced in the core passage; and a core kicker that is inclined and protruded inside the core passage to break the core introduced in the core passage into core pieces.

11. The seabed-core-sampling device described in claim 8, wherein the sampling robot further comprises a wobble-prevention mechanism that digs into the seabed to keep excavating position of the sampling robot.

12. A seabed-core-sampling method that comprises:
connecting a sampling robot through a first manipulator to a main robot that is moved under the sea by remote control;
moving the sampling robot with respect to the seabed;
introducing into a core tube a core from the seabed by excavating the seabed by rotating and feeding the core tube;
breaking the core into core pieces; and then housing the core pieces into a core rack provided in the main robot;
switching multiple core cases provided in the core rack by a second manipulator provided in the main robot;
connecting the core tube and the core rack through a suction hose; and
transferring the core pieces from the core tube to the core rack by the suction force of a suction pump provided in the main robot.
